(19) United States
(12) Patent Application Publication
(10) Pub. No.: US 2026/0159648 A1
(43) Pub. Date: Jun. 11, 2026

(54) Production of Modified Sulfur Binder and Uses Thereof

(71) Applicant: Uberbinder, Inc., Seattle, WA (US)

(72) Inventors: Jett Yang, Oxford (GB); Jonathan Davis, Faringdon (GB); Phil Ho Ahn, Pocheon-si Gyeonggi-do (KR)

(73) Assignee: Uberbinder, Inc., Seattle, WA (US)

(21) Appl. No.: 19/070,079

(22) Filed: Mar. 4, 2025

Related U.S. Application Data
(63) Continuation-in-part of application No. 18/636,021, filed on Apr. 15, 2024.
Application No. 18/636,021 is a continuation-in-part of application No. 16/963,146, filed on Jul. 17, 2020, now Pat. No. 11,975,966.

(51) Int. Cl. C08G 75/16; C04B 14/06; C04B 24/16; C04B 28/10

(52) U.S. Cl. CPC C08G 75/16; C04B 14/06; C04B 24/16; C04B 28/105

(57) ABSTRACT

A modified sulfur is produced using an environmentally-friendly material, exhibiting high functionality to solve problems of conventional modified sulfur, such as environmentally hazardous factors and odors. The invention also encompasses methods for producing concretes, coatings, waterproofings and other products using the modified sulfur as a binder, as well as the products thus made. In one aspect the modified sulfur includes sulfur and a modifier, wherein the modifier is a monounsaturated fatty acid-based modifier. Critical steps in producing the modified sulfur are disclosed, and in one embodiment the method is conducted in a multi-cell continuous flow reactor.

This application is a continuation-in-part of application Ser. No. 18/636,021, filed Apr. 15, 2024, which was a continuation-in-part of application Ser. No. 16/963,146, filed Jul. 17, 2020, now U.S. Pat. No. 11,975,966, issued May 7, 2024, which was a national filing from PCT/KR2020/000935, filed Jan. 20, 2020.

### BACKGROUND OF THE INVENTION

The present invention relates to environmentally-friendly modified sulfur and a production method thereof, as well as concretes, asphalt concretes, coatings and other products that include the modified sulfur as a binder.

Sulfur is a substance which has a flash point of 207° C. and a spontaneous ignition temperature of 245° C., exhibits ignitionability, and is easily combusted when the surface thereof is exposed to and comes in contact with air. Sulfur is not only obtained as natural sulfur derived from nature but also commonly generated during the desulfurization process of crude oil or natural gas.

Stable solid-phase sulfur exhibits high strength if the sulfur itself is not defective, whereas solid-phase sulfur, which is formed by cooling and solidifying liquid-phase sulfur, generally is present as a mixture of three forms, that is, an orthorhombic crystal system, a monoclinic crystal system, and an amorphous form. In the case of the solidified solid-phase sulfur, the mix of the three types of forms varies depending on cooling conditions, and the solidified sulfur itself is likely to become defective and brittle (have brittleness) over time. Therefore, pure sulfur has a very limited application range.

Although pure sulfur can be applied to various construction and civil engineering materials, the use thereof alone has a limitation due to the above-described characteristics. Specifically, sulfur materials having brittle fracture characteristics are unstable materials similar to typical Portland concrete in which very little plastic deformation takes place such that all of the force applied to the material tends toward destruction, causing instantaneous destruction when a force above yield strength is applied.

In order to solve these disadvantages, various types of sulfur modifiers have been considered. Especially, dicyclopentadiene (DCPD) is known to not only have high economic feasibility due to its low cost but also be effective for alleviating the brittleness of sulfur.

However, it is known that, since it is difficult to control the polymerization reaction of dicyclopentadiene and sulfur itself, there are a risk of an explosive exothermic reaction and a rapid increase in temperature and viscosity during the reaction.

Especially, when the polymerization reaction proceeds beyond an appropriate extent, it is known that a rubberization phenomenon may occur, and accordingly the reactor used for the polymerization reaction is damaged, which makes the commercial use of a sulfur modifier made of a dicyclopentadiene-based modifier and sulfur very difficult. In addition, dicyclopentadiene and sulfur are inefficient in production and application due to a supercooling phenomenon occurring after the polymerization reaction and present problems in actual application in road construction due to having environmentally hazardous issues and disgusting odors. Additionally, since dicyclopentadiene and sulfur have a difficulty in retaining constant quality due to the influence of external temperature, concrete products made therefrom can be unstable, exhibiting cracking, sinkage, and the like, after construction.

Potentially relevant documents are Korean Patent Pub. Nos. 10-2014-0000160, KR-2012-0096385 and 10-2011-0037127; WO 2015/112490; Smith, et al, “Crosslinker Copolymerization for Property Control in Inverse Vulcanization”, Chemistry A European Journal, vol. 25, pp 10433-10440 (2019); Worthington et al., “Laying waste to mercury: inexpensive sorbents made from sulfur and recycled cooking oils”, Chemistry A European Journal, vol. 23, pp 16219-16230 (2017); Smith et al., “Sulfur-Containing Polymers Prepared from Fatty Acid-Derived Monomers: Application of Atom-Economical Thiol-ene/Thiol-yne Click Reactions and Inverse Vulcanization Strategies:, Sustainable Chemistry (2020); Hoefling et al., “Sulfur-Based Polymer Composites from Vegetable Oils and Elemental Sulfur: A Sustainable Active Material for Li—S Batteries, Macromolecular Chemistry and Physics (2017).

### SUMMARY OF THE INVENTION

The present invention is directed to developing modified sulfur produced using an environmentally-friendly material and exhibits high functionality to solve problems of the conventional modified sulfur, such as environmentally hazardous factors, odors, and the like. The invention also encompasses methods for producing concretes, coatings and other products using the modified sulfur as a binder, as well as the products thus made.

One aspect of the present invention provides modified sulfur including sulfur and a modifier, wherein the modifier is an unsaturated fatty acid-based modifier.

Another aspect of the present specification provides a method of producing modified sulfur which includes a first step of mixing sulfur and an unsaturated fatty acid-based modifier, a second step of introducing the resulting mixture into a reactor and melting the mixture by heating to 100° C. to 130° C., preferably at least 120° C. to melt temperature, a third step of raising temperature of the melted mixture to about 160° C., and a fourth step of up to 180° C. to 190° C., terminating the reaction when the melted mixture exhibits spinnability or a network or honeycomb structure after cooling with a viscosity of about 4,000 cP to 25,000 cP.

Still another aspect of the present specification provides a concrete composition including the above-described modified sulfur and aggregate. The modified sulfur according to an embodiment of the present invention is environmentally friendly because the modified sulfur is produced while a petroleum-derived modifier is excluded or minimized and replaced with a modifier derived from nature.

In addition, the modified sulfur according to an embodiment of the present invention exhibits high functionality, that is, excellent properties in terms of adhesive strength, chemical resistance, flame retardancy, waterproofness, corrosion resistance, watertightness, flow resistance, equilibrium resistance, and the like.

### DESCRIPTION OF THE DRAWINGS

FIG. 1 is a flow chart illustrating a method of producing modified sulfur according to an embodiment of the present specification.

FIG. 2 is a diagram illustrating results of the wheel tracking test of Example 1, Comparative Example 1-2, and Comparative Example 1-3.

FIG. 3 is a diagram of measuring the moisture absorption rate of Example 4-1 and Comparative Example 4-1.

FIG. 4 shows images comparing the chemical resistances of Examples 5-1 to 5-3 and Comparative Example 5-1, while FIG. 5 is a photographic image (×750) of the microstructure of modified sulfur according to an embodiment of the present specification.

FIG. 6 is a graph showing unmodified sulfur viscosity plotted against temperature.

FIG. 7 is a schematic diagram showing a flow reactor system as adapted to the invention.

### DESCRIPTION OF PREFERRED EMBODIMENTS

### Modified Sulfur

One aspect of the present invention provides modified sulfur including sulfur and a modifier, wherein the modifier is an unsaturated fatty acid-based modifier.

According to an embodiment of the present invention, the modified sulfur has a viscosity in a range of about 4,000 cP to 25,000 cP room temperature. According to a more specific embodiment of the present specification, the modified sulfur may have a viscosity in a range of about 6,000 cP to 10,000 cP at room temperature.

In the present invention, the sulfur encompasses ordinary sulfur, and examples thereof include natural sulfur, sulfur obtained by desulfurization of petroleum or natural gas, and the like As the sulfur of the present invention, solid phase sulfur may be used after being heated to a temperature above the melting point thereof to facilitate a reaction, or liquid-phase sulfur discharged in a related industry such as petrochemicals and the like may be used. In addition, sulfur obtained by simply filtering impurity-containing waste sulfur discharged in a steel mill may be used.

In the present invention, the unsaturated fatty acid-based modifier may mean a compound including at least one carboxyl acid group and at least one carbon carbon double bond therein.

According to an embodiment of the present invention, the unsaturated fatty acid-based modifier may be a material obtained by using a fatty acid or an unsaturated fatty acid and then recycling the used fatty acid or unsaturated fatty acid or a material derived from nature. Therefore, a case where the unsaturated fatty acid-based modifier is included, as described in one aspect of the present invention, is environmentally-friendly compared to the conventional case where a petroleum-derived modifier is included.

According to one embodiment, the modifier is one or two or more selected from the group consisting of erucic acid, palmitoleic acid, elaidic acid, myristoleic acid, linoleic acid, arachidonic acid, gondoic acid, oleic acid, eicosapentaenoic acid, docosahexaenoic acid (DHA), a-linolenic acid, y-linolenic acid (GLA), and vegetable oils.

According to one embodiment, the vegetable oil may be selected from the group consisting of oils extracted from natural vegetable oils such as Chamaecyparis obtlisa oil, lemon oil, rose oil, lavender oil, sunflower seed oil, corn oil, mustard oil, castor oil, olive oil, cottonseed oil, Macadamia iiitegTifolia oil, flaxseed oil, pine oil, Hippophae rhaiimoides oil, Limaria bielims oil, canola oil, and the like.

According to an embodiment of the present invention, the modifier is included in an amount of 10 parts by weight or more and 450 parts by weight based on 100 parts by weight of the sulfur. Specifically, the modifier may be included in an amount of about 80 parts to 240 parts by weight based on 100 parts by weight of the sulfur. When the content of the modifier is less than 10 parts by weight based on 100 parts by weight of the sulfur, it may be difficult to maintain a liquid phase after synthesis and expect the functionality of the modified sulfur, and the brittleness of sulfur also remains, which causes a difficulty in use. On the other hand, when the content of the modifier is greater than 450 parts by weight based on 100 parts by weight of the sulfur, although the brittleness of sulfur does not remain, functionality, such as waterproofness, corrosion resistance, adhesion, chemical resistance, and the like, of the modified sulfur may be considerably degraded.

According to a preferred embodiment, the modified sulfur exhibits spinnability at room temperature. In the present invention, spinnability is expressed when the modified sulfur exhibits ‘threading’ or ‘stringing’ phenomenon resulting from the resistance to flow imparted by the liquid's internal friction, causing it to maintain cohesion and drips in elongated structures similar to syrup. The presence or absence of spinnability is determined by an experiment in which a glass rod is immersed in and taken out of a mixture or reaction product in a solution state during the production of modified sulfur. When after cooling, the ‘threading’ or ‘stringing’ phenomenon of 1 cm or longer is observed, the mixture or reaction product may be defined as having achieved spinnability.

According to one embodiment, the modified sulfur has a network structure or a honeycomb structure observable at room temperature. Since the modified sulfur according to a preferred embodiment of the invention includes an unsaturated fatty acid-based modifier, the double bond in the unsaturated fatty acid-based modifier may form a crosslink by polymerization so as to have a honeycomb structure or a network structure. In this case, functionality, such as adhesive strength, chemical resistance, flame retardancy, corrosion resistance, watertightness, flow resistance, high strength, and the like, of the modified sulfur may be enhanced.

FIG. 5 is a photographic image (approximately ×750×750) of the microstructure of the modified sulfur according to an embodiment of the present invention. Referring to FIG. 5, it can be seen that the modified sulfur according to an embodiment of the present invention has a microstructure, and specifically, the modified sulfur according to an embodiment of the present invention has a fibrous structure.

According to one embodiment, the modified sulfur is amphiphilic. Since the modified sulfur according to an embodiment of the present invention includes an unsaturated fatty acid-based modifier, amphiphilic modified sulfur may be provided.

Rusted and corroded metal surfaces need anti-corrosion treatment, and structures such as buildings and the like need waterproofing treatment for the purpose of preventing leaks and cracking and reinforcing durability. Since the conventional waterproof and anti-corrosion materials have limitations in repetitive coating formation, workability, posing an environmental risk, and the like and exhibit low durability due to low chemical resistance and low adhesive strength, an improvement in the lifetime of the product is required.

Although rubberized solid-phase modified sulfur with high viscosity has high enough chemical resistance and adhesive strength to be used as an alternative to epoxy fiber-reinforced plastic (FRP), a separate device such as a heated sprayer is required for high-temperature pretreatment for melting the modified sulfur so as to use the modified sulfur in the construction and repair/reinforcement of structures such as concrete structures or tunnel structures.

The modified sulfur according to an embodiment of the present invention may be amphiphilic modified sulfur with hydrophilicity and hydrophobicity. Due to having hydrophobicity, the modified sulfur may be used in a polymer concrete composition for paving and repairing or reinforcing the road just by mixing liquid phase modified sulfur, aggregate and hardener at room temperature without performing preheating and heating processes. In addition, due to having hydrophilicity, the modified sulfur may be used in a common Portland cement concrete working scheme by adding water, aggregate, a modified sulfur binder, and hydraulic materials (for example, a trace amount of a water-reducing agent, an antifoaming agent, a releasing agent, and the like) and mixing them at room temperature without performing preheating and heating processes.

According to an embodiment of the present invention, the modified sulfur may be in a liquid phase. In this case, high miscibility with materials and high dispersibility are exhibited, a heating process is not separately required in blending with hydraulic materials, and high modification effects may be realized even by using a small amount thereof. However, the modified sulfur may be subjected to various modifications, as necessary, and may be applied in various forms—for example, in a solid phase, a pellet form, a powder form.

According to one embodiment, the modified sulfur further includes a second modifier different from the unsaturated fatty acid-based modifier. Additional modifiers enable altering physical characteristics of the modified sulfur and products made therefrom, such as increasing or decreasing viscoelasticity of a paving product or allowing the liquid to set faster or slower.

According to one embodiment, the second modifier may be one or two or more selected from the group consisting of a saturated fatty acid-based modifier, an unsaturated fatty acid-based modifier, an alcohol-based modifier, an ester-based modifier, and a dicyclopentadiene-based modifier, although it is preferable to avoid any substantial proportion of DCPD.

The second modifier may be added optionally in the synthesis of modified sulfur depending on the area of application.

According to an embodiment of the present invention, the saturated fatty acid-based modifier may be stearic acid, palmitic acid, or the like, but the invention is not limited thereto.

According to an embodiment of the present invention, the unsaturated fatty acid-based modifier may be oleic acid or the like, but the invention is not limited thereto.

According to an embodiment of the present invention, the alcohol-based modifier may be glycerol or the like, but the invention is not limited thereto.

According to an embodiment of the present invention, the ester-based modifier may be a wax ester, dihydrocholesteryl oleate, or the like, but the invention is not limited thereto.

In the present invention, the dicyclopentadiene-based second modifier means a dicyclopentadiene-based modifier containing a cyclopentadiene oligomer. Dicyclopentadiene (DCPD), which is a dimer of cyclopentadiene (CPD), may be produced during the pyrolysis of naphtha, and any commercially available product may be used as long as it includes dicyclopentadiene.

Specifically, the dicyclopentadiene-based second modifier may be 1) dicyclopentadiene (DCPD), 2) a mixture of dicyclopentadiene and at least one selected from the group consisting of cyclopentadiene (CPD), DCPD derivatives, and CPD derivatives (methylcyclopentadiene (MCP), dicyclopentadiene (DCPD)), and 3) a mixture of 1) or 2) and at least one selected from the group consisting of olefin compounds such as dipentene, vinyl toluene, styrene monomers, and dicyclopentene.

According to an embodiment of the present invention, the second modifier may be included in an amount of 0.01 parts by weight to 300 parts by weight based on 100 parts by weight of the sulfur. The content range of the second modifier may be widely adjusted depending on the area of application of modified sulfur, specifically, depending on properties such as adhesion, hydrophobicity, waterproofness, corrosion resistance, and the like.

Specifically, when the dicyclopentadiene-based modifier is used as the second modifier, the dicyclopentadiene-based modifier is included in an amount of 0.01 parts by weight to 5 parts by weight based on 100 parts by weight of the sulfur. In addition, when the saturated fatty acid-based modifier, unsaturated fatty acid-based modifier, alcohol-based modifier, or ester-based modifier is used as the second modifier, the second modifier is included in an amount of 10 parts by weight to 300 parts by weight based on 100 parts by weight of the sulfur.

In the case of using the dicyclopentadiene-based modifier as the second modifier, when the dicyclopentadiene-based modifier is included in an amount of less than 0.01 parts by weight based on 100 parts by weight of the sulfur, it is difficult to provide modified sulfur with desired functionality, and when the dicyclopentadiene-based modifier is included in an amount of greater than 5 parts by weight based on 100 parts by weight of the sulfur, it is possible to provide modified sulfur with desired functionality, but it is difficult to use the modified sulfur in the field due to environmental risk and disgusting odors. More specifically, in the case of using dicyclopentadiene (DCPD) as the second modifier, when the DCPD is included in an amount of greater than 100 parts by weight based on 100 parts by weight of the sulfur, modified sulfur is not easily synthesized due to the occurrence of a spalling failure of DCPD during the synthesis reaction and despite having a viscosity of 10,000 cP or more after the synthesis, the modified sulfur cools to a solid phase thereby making it difficult to use without applying heat and making its application in the field almost impossible due to disgusting odors.

According to an embodiment of the present invention, the modified sulfur may further include one or two or more components selected from the group consisting of an initiator, a surfactant, a coupling agent, a catalyst, an additive, a crosslinking agent, and a dispersant. These components (or additives) help alter the physical performance of the binder, e.g., to bind in wet environment where the aggregate may contain excessive water or a catalyst (hardener/crosslinking agent) to adjust the speed at which the material sets, and dispersant in case the binder needs to be replace emissions.

Specifically, the initiator, surfactant, coupling agent, catalyst, additive, crosslinking agent, and dispersant are not particularly limited as long as they do not interfere with the polymerization reaction of the modified sulfur of the present invention and are materials commonly classified under the above names. The initiator, surfactant, coupling agent, catalyst, additive, crosslinking agent, and dispersant may serve to enhance the dispersion of the modified sulfur, form a hydrophilic or hydrophobic reactive group in the modified sulfur, and inhibit or promote crosslinking in the modified sulfur produced by the polymerization reaction.

According to an embodiment of the present invention, the initiator may be one or two or more selected from the group consisting of sulfur, modified sulfur, asphalt, sulfides, polysulfides, and hydrocarbon compounds. The initiator may be added simultaneously with the modifier or separately during the reaction. When the initiator is sulfur, the sulfur may be added during the reaction and applied as the initiator.

As the initiator, the sulfur may be elemental sulfur, crystalline sulfur, amorphous sulfur, colloidal sulfur, or a mixture thereof. In addition, the sulfur may be any one selected from the group consisting of α sulfur (orthorhombic sulfur), β sulfur (monoclinic sulfur), γ sulfur, and a combination thereof. The asphalt refers to straight asphalt or modified asphalt, and the sulfide may be a sulfur-containing compound, such as carbon disulfide or the like, but the present invention is not limited thereto. The polysulfide may be a polysulfide modified epoxy resin or the like, but the present invention is not limited thereto. The hydrocarbon compounds refer to compounds consisting of carbon and hydrogen and encompass straight-chain, branched-chain, cyclic, and aromatic hydrocarbon compounds. The initiator may be pre-polymerized modified sulfur and is not limited to modified sulfur produced by a specific method.

According to an embodiment of the present invention, the initiator may be one or two or more selected from the group consisting of trans-cinnamaldehyde, benzyl acetate, diethylaniline, nitroethane, formaldehyde hydrate, benzyl acetate, dodecylbenzenesulfonic acid, cetyl trimethyl ammonium bromide (CTMAB), methylmorpholine and morpholine, and dimethylaniline.

The above-exemplified initiators may be used alone, in combination of two or more thereof, or together with an initiator not exemplified above.

The initiator (functioning as a catalyst, activator, hardener or cross-linker) may serve to promote or adjust the polymerization of the unsaturated fatty acid-based modifier and the sulfur.

According to an embodiment of the present invention, the initiator may be included in an amount of 0.01 parts by weight to 2 parts by weight based on 100 parts by weight of the sulfur.

According to an embodiment of the present invention, the initiator may adjust the characteristics of produced modified sulfur by varying the specific type, addition amount, and addition point of an applied initiator, reaction conditions, and the like.

In the present invention, the surfactant may be one or two or more selected from the group consisting of an anionic surfactant, a cationic surfactant, a nonionic surfactant, and an amphoteric surfactant.

The anionic surfactant is a sulfate-based anionic surfactant, a sulfonate-based anionic surfactant, or other anionic surfactants. Examples of the sulfate-based anionic surfactant include alkyl sulfates, alkyl ester sulfates, alkyl ether sulfates, alkyl ethoxy ether sulfates, sulfated alkanolamides, glyceride sulfate, and the like, but the present invention is not limited thereto. Examples of the sulfonate-based anionic surfactant include dodecylbenzene sulfonate, including alkylbenzene sulfonate (ABS) and linear alkylbenzene sulfonate (LAS), hydrotropes and short tail alkylbenzene sulfonate, alpha-olefin sulfonates, lignosulfonates, sulfo-carboxylic compounds, including sodium lauryl sulfoacetate, and the like, but the present invention is not limited thereto. Examples of other anionic surfactants include organophosphorous surfactants, alkylamino acids including lauryl sarcosinate, sarcosine, and the like, but the present invention is not limited thereto.

The cationic surfactant is a linear alkylamine including a fatty amine linear alkyl ammonium including quaternary alkylammonium, a linear diamine, n-dodecylpyridinium chloride, imidazole, a morpholine compound, or the like, but the present invention is not limited thereto.

The nonionic surfactant is an ethoxylated alcohol, alkylphenol, fatty acid ester, or nitrogenated nonionic surfactant. Examples of the ethoxylated alcohol and alkylphenol nonionic surfactants include linear ethoxylated alcohols, ethoxylated alkylphenols, ethoxylated thiols, nonylphenols, octylphenols, and the like, but the present invention is not limited thereto. Examples of the fatty acid ester nonionic surfactant include polyethoxy esters, glycerol esters, hexitol, cyclic anhydrohexitol esters, and the like, but the present invention is not limited thereto. Examples of the nitrogenated nonionic surfactant include ethoxylated amines, imidazole (cyclic alkyl diamine), ethoxylated alkyl amides, tertiary amine oxides, and the like, but the present invention is not limited thereto.

The amphoteric surfactant is aminopropionic acid, iminopropionic acid, a quaternary compound, or the like. Examples of the quaternary compound include sulfobetaine-based surfactants and the like, but the present invention is not limited thereto.

In the present invention, when the surfactant is selected and applied depending on the area of application of the modified sulfur, specific functionality required depending on the area of application in the production of the modified sulfur may be enhanced.

In the present invention, the coupling agent may be one or two or more selected from the group consisting of a silane-based coupling agent, a titanate-based coupling agent, and a chromium-based coupling agent, and surfactants used in the art may be used.

The silane-based coupling agent may be any one selected from the group consisting of a sulfide-based silane compound, a mercapto-based silane compound, a vinyl-based silane compound, an amino-based silane compound, a glycidoxy-based silane compound, a nitro-based silane compound, a chloro-based silane compound, a methacrylic-based silane compound, and a combination thereof, but the present invention is not limited thereto.

The titanate-based coupling agent may be any one selected from the group consisting of isopropyl triisostearoyl titanate, isopropyl tridodecylbenzenesulfonyl titanate, isopropyl tri(dioctylpyrophosphate) titanate, tetraisopropyl di(tridecylphosphite) titanate, tetraisopropyl di(dioctylphosphite) titanate, tetraoctyloxytitanium (ditridecylphosphite), and a combination thereof, but the present invention is not limited thereto.

In the present invention, when the coupling agent is used, the interfacial adhesive strength of the modified sulfur may be enhanced, and when the modified sulfur is used in combination with heterogeneous materials, adhesion with the heterogeneous materials may be enhanced, which is advantageous for forming a composite material.

In the present invention, the additive may be an inorganic or resin additive and may specifically be one or two or more selected from the group consisting of silica sand, diatomite, wollastonite, clay, chopped glass fiber, a dye, a pigment, aluminum sulfate, water glass, Ca(OH)₂, zinc oxide, naphthalene, Mg(OH)₂, Al(OH)₃, borax, CaSO₄ 2WO, Fe₂0₃, a zeolite, carbon black, talc, a carbon fiber, clay, a whisker, MgSO₄ 7W0, fly ash, an acrylic emulsion, epoxy, latex, a carbon fiber or sheet, a steel fiber, a liquid mineral, titanium dioxide, a fibrous filler, a fibrous particle, a flaky particle, crushed recycling waste, and a combination thereof. Most of these additives are used after the modified sulfur has been produced, to make a concrete or asphalt-like or other end product.

According to an embodiment of the present invention, the additive may be included in an amount of 0.1 parts by weight to 30 parts by weight based on 100 parts by weight of the sulfur.

The crosslinking agent may be a sulfur-based crosslinking agent, an organic peroxide, a resin crosslinking agent, or a metal oxide such as magnesium oxide or the like. The sulfur-based crosslinking agent may be an inorganic crosslinking agent such as powder sulfur (S), insoluble sulfur (S), precipitated sulfur (S), colloidal sulfur, or the like, or an organic crosslinking agent such as tetramethylthiuram disulfide (TMTD), tetraethylthiuram disulfide (TETD), dithiodimorpholine, or the like, but the present invention is not limited thereto. Specifically, the sulfur-based crosslinking agent may be elemental sulfur or a vulcanizing agent that forms sulfur·amine disulfide), polymeric sulfur, or the like, but the present invention is not limited thereto. The organic peroxide may be any one selected from the group consisting of benzoyl peroxide, dicumyl peroxide, di-t-butyl peroxide, t-butyl cumyl peroxide, methyl ethyl ketone peroxide, cumene hydroperoxide, 2,5-dimethyl-2,5 di(t-butylperoxy)hexane, 2,5-dimethyl-2,5-di(benzoylperoxy)hexane, 2,5-dimethyl 2,5-di(t-butylperoxy)hexane, 1,3-bis(t-butylperoxypropyl)benzene, di-t-butylperoxy 1 0 diisopropylbenzene, t-butyl peroxy benzene, 2,4-dichlorobenzoyl peroxide, 1,1 dibutylperoxy-3,3,5-trimethyl siloxane, n-butyl-4,4-di-t-butylperoxyvalerate, and a combination thereof, but the present invention is not limited thereto. The dispersant may be used to enhance miscibility between the modified sulfur and the surfactant, between the modified sulfur and the coupling agent, or between the modified sulfur and a reinforcing material As the dispersant, any dispersant may be used as long as it may enhance the degree of dispersion when modified sulfur is mixed with a surfactant, a coupling agent, a reinforcing material, or the like. In addition, the surfactant may also act as the dispersant to the extent that it plays a role in enhancing the degree of dispersion during the mixing.

As the dispersant, any one polymer dispersant selected from the group consisting of polyvinylpyrrolidone, polyethyleneimine, polyacrylic acid, carboxymethyl cellulose, polyacrylamide, polyvinyl alcohol, polyethylene oxide, starch, gelatin, and a combination thereof may be used, but the present invention is not limited thereto.

One or two or more selected from the group consisting of the initiator, surfactant, coupling agent, catalyst, additive, crosslinking agent, and dispersant may be mixed with modified sulfur in a solvent, in the production of a modified sulfur concrete or asphalt-like product.

As the solvent, any conventional solvent may be used without limitation as long as it helps to mix the modified sulfur with the initiator, surfactant, coupling agent, catalyst, additive, crosslinking agent, and/or dispersant and does not interfere with the polymerization of the modified sulfur.

The solvent may be one or two or more selected from the group consisting of water, an aromatic hydrocarbon-based solvent, an aliphatic hydrocarbon-based solvent, an ether-based solvent, an alcohol-based solvent, a polyol solvent, an amide based solvent, an acetate-based solvent, a non-aqueous inorganic solvent, an amine based solvent, an ester-based solvent, a ketone-based solvent, and a sulfone-based solvent.

The aliphatic or aromatic hydrocarbon-based solvent may be any one selected from the group consisting of toluene, xylene, Aromasol, chlorobenzene, hexane, heptane, octane, dodecane, cyclohexane, decane, tetradecane, hexadecane, octadecane, octadecene, nitrobenzene, o-nitrotoluene, anisole, mesitylene, and a combination thereof, but the present invention is not limited thereto.

The ether-based solvent may be any one selected from the group consisting of diethyl ether, dipropyl ether, dibutyl ether, dioxane, tetrahydrofuran, diisobutyl ether, isopropyl ether, octyl ether, tri(ethylene glycol) dimethyl ether, and a combination thereof, but the present invention is not limited thereto.

The alcohol-based solvent may be any one selected from the group consisting of methanol, ethanol, 1-propanol, 2-propanol, 1-butanol, 2-butanol, isobutanol, hexanol, isopropyl alcohol, ethoxy ethanol, ethyl lactate, octanol, isopropyl alcohol, ethylene glycol monomethyl ether, benzyl alcohol, 4-hydroxy-3-methoxy benzaldehyde, isodeconol, butyl carbitol, terpineol, alpha-terpineol, beta-terpineol, cineole, and a combination thereof, but the present invention is not limited thereto.

The polyol solvent may be any one selected from the group consisting of glycerol, glycol, ethylene glycol, diethylene glycol, triethylene glycol, tetraethylene glycol, propylene glycol, dipropylene glycol, butanediol, hexylene glycol, 1,2 pentanediol, 1,2-hexanediol, glycerin, polyethylene glycol, polypropylene glycol, ethylene glycol monomethyl ether (methyl cellosolve), ethylene glycol monoethyl ether (ethyl cellosolve), ethylene glycol monobutyl ether (butyl cellosolve), diethylene glycol monoethyl ether, diethylene glycol monobutyl ether, and a combination thereof, but the present invention is not limited thereto. [0128] The amide-based solvent may be any one selected from the group consisting of N methyl-2-pyrrolidone (NMP), 2-pyrrolidone, N,N-dimethylacetamide, and a combination thereof, but the present invention is not limited thereto.

The amine-based solvent may be any one selected from the group consisting of primary amines such as propylamine, n-butylamine, hexylamine, octylamine, and the like, secondary amines such as diisopropylamine, di(n-butyl)amine, and the like, tertiary amines such as trioctylamine, tri-n-butylamine, and the like, alkyl amines such as ethylamine, propylamine, butylamine, hexylamine, octylamine, trioctylamine, and the like, cyclic amines, aromatic amines, and a combination thereof, but the present invention is not limited thereto.

The ester-based solvent may be any one selected from the group consisting of PEGMEA, ethyl acetate, n-butyl acetate, γ-butyrolactone, 2,2,4 trimethylpentanediol-1,3-monoisobutyrate, butyl carbitol acetate, butyl oxalate, dibutyl phthalate, dibutyl benzoate, butyl cellosolve acetate, ethylene glycol diacetate, ethylene glycol diacetate, and a combination thereof, but the present invention is not limited thereto

The ketone-based solvent may be any one selected from the group consisting of acetone, methyl ethyl ketone, methyl isobutyl ketone, 1-methyl-2-pyrrolidinone, cyclohexanone, and a combination thereof, but the present invention is not limited thereto.

The amide-based solvent may be any one selected from the group consisting of N-methyl-2-pyrrolidone (NMP), 2-pyrrolidone, N,N-dimethylacetamide and a combination thereof, but the present invention is not limited thereto.

The sulfone-based solvent may be any one selected from the group consisting of diethyl sulfone, tetramethylene sulfone, and a combination thereof, but the present invention is not limited thereto.

The acetate-based solvent may be any one selected from the group consisting of ethyl acetate, butyl acetate, propylene glycol methyl ether acetate, and a combination thereof.

The non-aqueous inorganic solvent may be carbon disulfide, liquid ammonia, or the like, but the present invention is not limited thereto.

According to an embodiment of the present invention, the modifier is a binder produced by melt polymerization of sulfur and an environmentally-friendly modifier and generally is in a liquid or gel phase at room temperature. In addition, a modifier in a solid phase (powder or pellet form), which is obtained by maximizing polymerization in the melt polymerization depending on an intended purpose, may include any one selected from the group consisting of ethanol, methanol, methyl ethyl ketone (MEK), toluene, m-xylene, p-xylene, and the like as a diluent to be mixed when used as a material for a waterproofing agent and an anti-corrosion agent. The intended purpose may refer to increasing hydrophobicity, waterproofness, corrosion resistance, chemical resistance, adhesion, high strength, and the like, as necessary.

### Method of Producing Modified Sulfur

Another aspect of the present invention provides a method of producing modified sulfur which includes a first step of mixing sulfur and an unsaturated fatty acid-based modifier, a second step of introducing the resulting mixture into a reactor and melting the same by heating to at least 120° C., a third step of raising the temperature of the melted mixture, gradually, to about 160° C. (ring opening temperature), a fourth step of raising the temperature very gradually (e.g. 2° C. to 3° C. per hour) to about 180° C. to 190° C., and a fifth step of terminating the reaction when spinnability or honeycomb or microstructures occur and is observable at ambient temperature and when viscosity of the mixture reaches 6,000 cP to 25,000 cP when measured at room temperature.

According to an embodiment of the present invention, the modified sulfur produced by the method may be applied in the same manner as in the above described description of modified sulfur unless contradicted by the following description.

According to an embodiment of the present invention, the first step of mixing sulfur and an unsaturated fatty acid-based modifier is carried out so that the unsaturated fatty acid-based modifier is included in an amount of 10 parts by weight to 450 parts by weight based on 100 parts by weight of the sulfur.

According to one embodiment, in the first step, a second modifier may be further included in the above-described content range.

According to one embodiment, one or two or more selected from the group consisting of the initiator, surfactant, coupling agent, catalyst, additive, crosslinking agent, and dispersant may be further included in the above-described content range. According to one embodiment, the first step may be carried out at room temperature (about 15° C. to 25° C.) or above.

According to an embodiment of the present invention, in the second step, the mixture may be melted by heating to 100° C. to 130° C. Preferably and specifically, in the second step the mixture may be melted by heating to an internal temperature of at least about 120° C., and polymerization is initiated.

Specifically, in the second step, the mixture is introduced into a polymerization reactor, the temperature of the polymerization reactor is set to about 120° C. using a temperature controller, the introduction of the mixture into the polymerization reactor is terminated, and melt polymerization is initiated. In addition, at the polymerization reactor temperature of about 120° C., melt polymerization may proceed while the blade of the reactor is stopped until sulfur and other mixing materials completely become a liquid and then rotated when the mixture has been converted into a liquid.

According to an embodiment of the present invention, after the mixture becomes a liquid in the second step, the third step of raising temperature of the liquid-phase mixture can be carried out.

According to an embodiment of the present invention, the third step of raising temperature of the melted mixture may be carried out by gradually raising temperature of the melted mixture, to a temperature of about 160° C. Preferably this takes place over at least about two hours.

According to one embodiment, the third step of raising temperature of the melted mixture may be carried out so that temperature outside the reaction and temperature within the melted mixture differ by 20° C. or less. More specifically, temperature of the polymerization reactor may be gradually raised so that temperature variance inside and outside the reaction is as small as possible (about 5° C. or less). When the temperature elevation rate is high, an exothermic reaction of sulfur and modifier occurs, and thus the temperature inside the reactor is rapidly raised, causing a difficulty in temperature control and the occurrence of carbonization. Preferably a double-jacketed oil-heated reactor is used to control reaction temperature closely.

According to an embodiment of the present invention, when the temperature of the melted mixture is 160° C. or more, the state and viscosity of the melted mixture (after cooling of a sample) are measured three times or more per hour. The fourth step of raising temperature to 180° C. to 190° C. is done very slowly, preferably at about 2° C. to 3° C. per hour (preferably 2.5° C.), as this is a very critical range in which a runaway reaction must be avoided. In such a reaction temperature in the exothermic reaction quickly races to dangerous and destructive levels.

The fifth step of terminating the reaction may be carried out depending on the intended area of application. Specifically, when the reaction is terminated when, after reaching at least 160° C. in the reaction, the viscosity reaches 6,000 cP to 15,000 cP at ambient temperature, the modified sulfur thus produced may be used for room-temperature asphalt or modified sulfur polymer concrete, and when the reaction is terminated when the viscosity reaches 6,000 cP to 25,000 cP, the modified sulfur thus produced may be used for waterproofing paint or anti-corrosion paint.

According to an embodiment of the present invention, the melted mixture has an ambient-temperature viscosity of 4,000 cP to 25,000 cP when the temperature in the reaction has been brought to 160° C. or above.

When the reaction time of the fourth step is prolonged, rubberized modified sulfur with high viscosity can be provided. In this case, the modified sulfur may be used for a waterproofing material and an anti-corrosion material by using a diluent. In addition, the high-viscosity modified sulfur produced in a solid phase or in a powder form may provide properties such as waterproofness, corrosion resistance, high adhesion, chemical resistance, and the like, when added in the construction of roads and concrete structures and may be applied in various applications such as a fast-setting repairing agent, a fast-setting water-stopping agent, a waterproofing sheet, antimicrobial silicone, paint, a waterproofer and tile adhesive, for example, due to its high viscosity.

According to an embodiment of the present invention, the fifth step of terminating the reaction can be carried out when viscosity of the melted mixture, whose temperature has been raised in the fourth step, reaches a range of 6,000 cP to 25,000 cP as measured after cooling to ambient temperature. That is, according to an embodiment of the present invention, the time point where viscosity of the melted mixture, whose temperature has been raised in the fourth step, preferably to above 160° C., reaches 6,000 cP to 25,000 cP at ambient temperature, may be referred to as the end point of the reaction.

According to an embodiment of the present invention, the reaction is terminated when spinnability is achieved and viscosity of the melted mixture reaches 6,000 cP to 25,000 cP.

Specifically, the end point of the reaction may be determined as a time point where spinnability is observed or where a microstructure such as a fibrous or flaky structure caused by increased adhesion of the melted mixture is observed.

In addition, the end point of the reaction may be at a time point where rubberization proceeds, before carbonization occurs.

According to an embodiment of the present invention, when the reaction is terminated in the fifth step, the temperature inside the reactor at termination may be about 160° C. to about 200° C., more preferably about 160° C. to about 190° C.

The reaction product of the fifth step of terminating the reaction may have a viscosity of (at room temperature) 5,000 cP to 2,000,000 cP. Note that honey, corn syrup, and molasses have viscosity that ranges from 2000 to 10,000 cP.

According to an embodiment of the present invention, after the fifth step, an aging step is further included. The aging step is carried out by aging the produced binder at 40° C. or more (after cooling from about 160° C. to 190° C.). The aging step can allow further control of viscosity, generally increasing viscosity with longer aging time.

Specifically, the aging step may be carried out at 40° C. to 120° C. In the aging step, viscosity of the modified sulfur may be adjusted depending on the area of application. For example, if a binder is produced for one purpose at a relatively low viscosity, aging can be used to increase viscosity to make the binder suitable for another purpose.

According to an embodiment of the present invention, the method of producing modified sulfur, that is, the first to fifth steps, may proceed for about 6 hours to about 18 hours, but the process time will vary depending on the application for which the binder material is to be used.

In the method of producing modified sulfur, the mixture of sulfur and a modifier is gradually subjected to polymerization while undergoing the second step (polymerization beginning step), and the melted mixture may undergo a color change in the order of yellow, wine, red, semitransparent dark brown, and opaque black in the process of raising the temperature. An initiator may be added between the time points where the color of the mixture is changed, and another initiator may also be added just before the end of the reaction.

According to an embodiment of the present invention, the addition point, type, and addition amount of the initiator may be adjusted in accordance with the area of application of the modified sulfur so as to adjust properties of the modified sulfur.

In addition, according to an embodiment of the present invention, the mixture produced in the first step, the polymerization temperature and time, and the end point of the reaction may be adjusted depending on the area of application of the modified sulfur so as to adjust viscosity.

### Example of Procedure, Laboratory Production

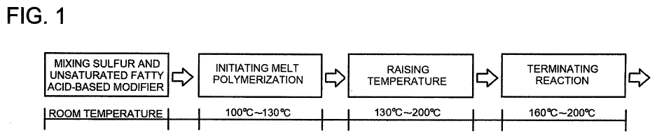

Below is a simplified production method of the invention when oleic acid is used as the sole modifier. This indicative 4-step process typically takes approximately 10 hours:
Step 1:100 parts of sulfur is mixed with 120 parts of oleic acid (by weight) that has been pre-heated to 120° C.
Step 2: Mixture heated to at least 120° C., preferably somewhat higher, with stirring.
Step 3: Mixture is continually stirred to achieve homogeneity while the temperature of the mixture is evenly elevated to 160° C. in steady increments over 2 hours (see FIG. 1).
Step 4: Once the temperature of the mixture reaches ROP (Ring Opening Polymerization) temperature of 160° C., the mixture is evenly elevated in slower/steady increments of about 2.5° C. per hour while continually stirred to maintain homogeneity. This step could take approximately 8 hours from step 3.
From 160° C. to 180° C.-190° C., the mixture of the reaction product is checked for spinnability (of sample cooled to ambient temperature) every 15 minutes.
Step 5: Synthesis is terminated when the mixture exhibits spinnability (with viscosity ranging from 4,000 cP to 25,000 cP) when checked at ambient temperature. The entire mixture is then allowed to cool to room temperature.
NB: The mixture or reaction product may be defined as having spinnability when it exhibits the characteristics described above.

| Time | 0 hr | 1 hr | 2 hr |
|---|---|---|---|
| Temp. | 120° C. | 140° C. | 160.0° C. |

| Time | 3 hr | 4 hr | 5 hr | 6 hr | 7 hr | 8 hr | 9 hr | 10 hr |
|---|---|---|---|---|---|---|---|---|
| Temp. | 162.5° C. | 165.0° C. | 167.5° C. | 170.0° C. | 172.5 | 175.0° C. | 177.5° C. | 180.0° C. |
| Check for | every | every | every | every | every | every | every | every |
| Spinnability | 15 min. | 15 min. | 15 min. | 15 min. | 15 min. | 15 min. | 15 min. | 15 min. |

It is to be noted that when (a) the reaction temperature is 120° C. or lower, the polymerization between sulfur and modifying agent is insignificant or not accomplished, and (b) when the reaction temperature exceeds 200° C., it may be difficult to control explosive reaction, materials under the reaction process may erupt, and explosion or carbonation of the reactant may occur; hence, 130° C. to 190° C. as the reaction temperature is the most preferable in terms of reaction control or productivity.

During the polymerizing process, the sulfur and the modifying agent react with each other, passing through mixing, evaporation, and liquefaction and color of the mixture changes in order of transparency: yellow, wine, red, semitransparent dark brown and opaque black.

During the terminating process, micro-structures such as fiber, film, or network structure, which can be controlled by reaction conditions, i.e., the end point of the reaction and the reaction temperature, are formed, and remain as the product cools to ambient temperature. The end point of the reaction may be between the time when the first reactant obtains spinnability and the time when rubberization of the first reactant occurs. At spinnability, the reactant will be of the film-like micro-structures with superior adhesiveness and elastic modulus. At rubberization state, the product will be of the fiber-like or network-like microstructure (both observed at ambient temperature). The end point can be determined according to the intended application of the binder product, e.g., when the mixture viscosity is more than 10,000 cP, particularly 10,000 cP to 1 million cP.

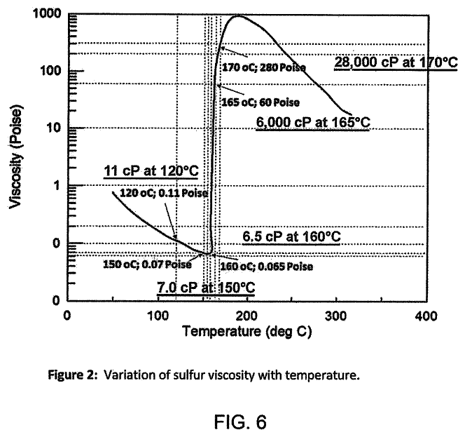

The mixing temperatures are guided by the unmodified sulfur viscosity variations with temperature shown in FIG. 6.

In a variation of the process the reaction time can be significantly reduced. Experimentation was conducted as described below.

To observe the reaction kinetics of the synthesis of the modified sulfur product, with oleic acid as the modifier, also known as S-OA (sulfur-oleic acid), the reaction was carried out in a 40 mL reaction vial on a 20 g scale at 180° C. with stirring at 1500 rpm (maximum speed) using a 20 mm cross-shaped polytetrafluoroethylene stirrer bar. A standard 1:1.2 ratio of sulfur-to-oleic acid (OA) was used. A higher temperature of 180° C. allowed the reaction to be pushed to faster rates, and 20 g provided enough mixture for aliquots to be taken for NMR (nuclear magnetic resonance) analysis. The initial aliquot was taken 5 minutes into the reaction, then the following aliquots were taken every 15 minutes from the start of the reaction. The initial aliquot was taken 5 minutes into the reaction instead of at 0 minutes to allow both phases to mix first to obtain an aliquot which contained a 1:1.2 ratio of sulfur-to-OA. After each aliquot was taken, the sample was placed in a freezer to fully quench the reaction. Spinnability (the end point) was reached after 2 hours.

A calculation was made as to the amount of oleic acid that had reacted. The C═C double bond in OA that reacts with sulfur was tracked using NMR to observe the rate at which the OA was consumed. For each aliquot, 50 mg of sample was dissolved in 2 mL of CdCl₃. This showed a gradual change in color of the solution from yellow to brown as the reaction progressed. The results in this experiment indicated a conversion of 96.2% of the OA in the reaction.

The above experiment indicates that the reaction can be shortened, to a time of no more than 2 hours. However, in a further variation of the process, the reactions can be conducted in a multi-cell continuous flow reactor. Flow chemistry is well known, in which a chemical reaction is conducted in a continuously flowing stream rather than in batch production. Pumps move fluid into and through the reactor, where tubes or channels join a series of cells, the fluids being thoroughly mixed by movement through the narrow channels into cells and through further channels, etc. The reaction takes place in the progression of the reactants through the multi-cell flow reactor. Flow chemistry is a well-known technique for use at large scale when a material is to be manufactured in large quantities. However, it is also used at laboratory scale by chemists and in small pilot plants and lab-scale continuous plants. A multi-cell continuous flow reactor can be at any scale, but preferably a relatively small-scale reactor is used, and this can be scaled up for manufacturing by using several or a large number of multi-cell flow reactors in parallel.

In such a reactor mixing can be achieved very quickly, within seconds, at the smaller scales used in flow chemistry. Heat transfer is intensified based on the area to volume ratio being large. Thus, endothermic and exothermic reactions can be controlled easily and consistently. The temperature gradient in the reactor can be steep, allowing efficient control over reaction time. The relatively small cells of the multi-cell reactor can be closely and individually controlled. Thermal runaways are avoided. The small reaction volume provides a safety benefit.

Further, flow reactions can be automated far more easily than with batch reactions. This can allow for smoother operation, less requirement for personnel attending the reaction. If needed, an automated system can be created to sequentially investigate a range of possible reaction parameters, with variations in stoichiometry, residence time and temperature, so that reaction parameters can be explored. The multi-cell continuous flow reactor can produce higher yields with greater selectivity, and with less manpower and higher safety.

Thus, with one or more multi-cell flow reactors, multi-step reactions can be arranged in a continuous sequence, which is especially advantageous if compounds or mixtures are unstable, toxic, sensitive to air or subject to exothermic runaway. The continuous reactor is typically formed with small channels or tubes that connect a series of small cells. Such a reactor is formed from non-reactive materials such as stainless steel, glass or even some polymers. Mixing occurs by movement of the fluids alone, since the channels between cells are small, and can be as small as 1 mm or less. Movement through the channels and into the reactor cells automatically causes essentially constant mixing of the reactants, which is particularly important in the current invention. Transfer to the various cells, reaction time and mixing are thus closely controlled in the multi-cell flow reactor. Note that other flow reactors could be used, such as spinning disk reactors, spinning tube reactors, or oscillatory flow reactors.

One example of such a multi-cell continuous flow reactor is one produced by Corning, i.e. CORNING ADVANCE-FLOW Reactor, although other multi-cell continuous flow reactors have been known and used in chemical reactions, such as those of Chemtrix Modular Systems (chemtrix.com), and Ehrfeld Mikrotechnik Modular Systems (ehrfeld.com/en).

The current invention, i.e. the method of production of the modified sulfur product, lends itself particularly to multi-cell continuous flow reaction. The sulfur can be fed into the reactor in a molten state (above 120° C.), along with the modifier, preferably an unsaturated fatty acid modifier such as oleic acid and possibly an additional modifier/catalyst. These components are continually mixed as they pass through narrow channels and through reactor cells. The temperature at each reactor cell can easily be closely controlled, due to the small volume and large surface area involved. Thermal runaway can easily be avoided through cell-by-cell temperature control. The flow rate and thus the reaction time (for a given temperature) can be controlled by the rate of pumping of the components into the reactor.

With the modified sulfur reaction conducted in multi-cell continuous flow reactors, the reaction time to produce the modified sulfur product, exhibiting spinnability or microstructures at room temperature, can be accomplished in less than one hour, and even less than thirty minutes. With the controls allowed by the multi-cell reactor, temperature can be raised very quickly up to 160° C. to 180° C., and higher if desired for a particular result. As noted above, different maximum temperatures, along with reaction time, can produce modified sulfurs useful for different purposes (pavement, coatings, sealants, waterproofing materials, etc.).

### Summary of Process in Multi-Cell Continuous Flow Reactor:

### 1. Raw Materials Preparation

Sulfur: Elemental sulfur (S) in molten state is used as the primary reactant.
Fatty Acids: Fatty acids (e.g., oleic acid, linoleic acid) act as comonomers and crosslinkers. These are derived from plant or animal based natural oils.
Catalyst/Modifiers: Catalysts (e.g., amines or bases) can be used to accelerate the reaction and modifiers (small amounts of dicyclopentadiene or polypropylene) can be used to enhance the performance characteristics of the binder.

### 2. Flow Reactor Setup

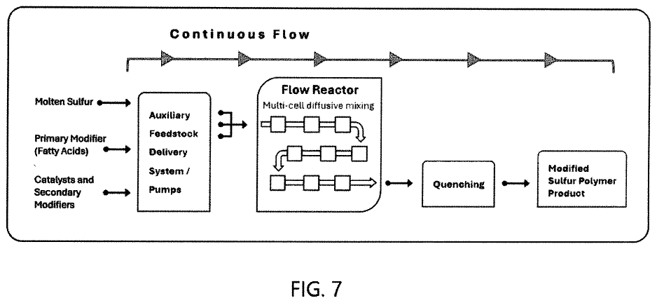

The flow reactor system consists of (see FIG. 7):
Feedstock Delivery System: Pumps to deliver the molten sulfur, fatty acids and catalysts/modifiers in precise ratios.
Mixing Unit: A static or dynamic mixer to ensure homogeneous mixing of reactants. Mixing can be performed in the flow reactor, as diffusive mixing. The reactor channels (and cells) can include baffles and bends to generate turbulence and thorough mixing. The narrow pathways themselves promote mixing as well
Reaction Zone: A heated tubular reactor, multi-cell reactor or microreactor where the polymerization occurs.
Temperature Control System: To maintain the reaction at the desired temperature (typically 120° (sulfur m.p.) to about 180° C.), or a range of about 160° C. to 180° C.).
Quenching Unit: To cool the product stream quickly and stop the reaction. In some cases this could be a final step in the flow reaction, but normally done in a separate heat exchanger.

### 3. Reaction Mechanism

The reaction involves the ring-opening polymerization of sulfur (S) and its subsequent copolymerization with fatty acids.
Key Steps:
1. Sulfur Ring Opening: At elevated temperatures, S₈ rings break open to form reactive diradicals (Sₙ·).
2. Copolymerization: The fatty acids react with the sulfur diradicals, forming polysulfide chains with ester or thioester linkages.
3. Crosslinking: Fatty acids with multiple double bonds (e.g., oleic or linoleic acid) can introduce crosslinks, enhancing the polymer's mechanical properties.

### 4. Process in the Flow Reactor (FIG. 7)

Step 1: Molten sulfur and fatty acids are pumped into the system at controlled flow rates.
Step 2: The reactants are mixed thoroughly in the mixing unit, which can be a first part of the flow reactor.
Step 3: The mixture enters the heated reaction zone, where polymerization occurs. The residence time is carefully controlled to achieve the desired molecular weight and conversion.
Step 4: The product stream is cooled in the quenching unit to stabilize the polymer. The quenching unit can in some cases be in a downstream end of the flow reactor. With quenching, the reaction in some cases is stopped

### 5. Advantages of Using a Flow Reactor

Precise Control: Flow reactors allow for precise control of temperature, residence time, and reactant ratios, leading to consistent product quality.
Scalability: The process can be easily scaled up for industrial production.
Safety: The continuous flow minimizes the risk of overheating or runaway reactions.
Efficiency: Improved heat and mass transfer, and precision of control, enhance reaction efficiency.

### 6. Post-Processing

The resulting polysulfide polymer may undergo additional processing, such as:
Purification: Removal of unreacted monomers or byproducts.
Formulation: Blending with additives to tailor properties (e.g., flexibility, adhesion).
Curing: Crosslinking to achieve the final polymer network.

By leveraging a flow reactor system, the synthesis of polysulfide polymers from sulfur and fatty acids becomes a highly efficient and controllable precision process, suitable for both research and industrial applications.

### Concrete Composition

Still another aspect of the present invention provides a concrete composition including the above-described modified sulfur and aggregate.

According to an embodiment of the present invention, the modified sulfur included in the concrete composition may be applied in the same manner as in the above-described description of modified sulfur unless contradicted by the following description.

Since the concrete composition according to an embodiment of the present invention includes the modified sulfur, fluidity is enhanced, which is advantageous for mixing with aggregate in a short time. In addition, since the modified sulfur has a honeycomb structure or a network structure, adhesive strength, waterproofness, elasticity, and/or strength may be enhanced Furthermore, the modified sulfur according to an embodiment of the present invention solves the problems, such as brittleness and odors, of sulfur and is environmentally-friendly.

In the present invention, the aggregate may be any one selected from the group consisting of recycling industrial waste, steel sand, crushed stone, fly ash, sea sand, quartz sand, gravel, silica, quartz powder, lightweight aggregate, clay minerals, glass powder, and a combination thereof.

The recycling industrial waste refers, for example, to waste lime powder sludge in which lime powder generated when aggregate is pulverized is precipitated with a sodium acrylate copolymer flocculant and which is waste having a difficulty in landfilling because it is treated like waste. However, any industrial waste may be applied as the recycling industrial waste as long as it can be used as the aggregate, and the present invention is not limited to the waste lime powder sludge.

When fine aggregate having a particle diameter of 1 to 10 mm is used as the aggregate, the aggregate may be applied to mortar, and when the fine aggregate and coarse aggregate having a particle diameter of 10 to 18 mm are used together as the aggregate, the aggregate may be applied to concrete.

According to an embodiment of the present invention, based on 100 parts by weight of the concrete composition, the modified sulfur may be included in an amount of 1 part by weight or more and 80 parts by weight or less, and the aggregate may be included in an amount of 70 parts by weight or more and 95 parts by weight or less.

According to an embodiment of the present invention, the concrete composition may be a polymer concrete composition, that is, a resin concrete composition.

According to an embodiment of the present invention, the concrete composition may be applied alone or in combination in the field of latex-modified concrete (LMC) or ultra-rapid hardening cement.

According to an embodiment of the present invention, the concrete composition may be a hydraulic polymer concrete composition.

According to an embodiment of the present invention, the hydraulic polymer concrete composition is capable of being dissolved in water at room temperature, that is, has hydrophilicity. Therefore, the concrete composition may be used after being dissolved in water and then melt-mixed with a water-reducing agent, a releasing agent, an antifoaming agent, and other modifiers or may be used after being melted first and melt-mixed with a water-reducing agent, a releasing agent, an antifoaming agent, and other modifiers.

According to an embodiment of the present invention, the concrete composition may further include a binder. As the binder, a resin, for example, latex, lacquer, epoxy, and methyl methacrylate (MMA), may be used.

Since the concrete composition according to an embodiment of the present invention is thermoplastic like the conventional asphalt, uniform mixing is possible during the melt mixing process.

According to an embodiment of the present invention, the concrete composition may further include a filler.

According to an embodiment of the present invention, the filler may be included in an amount of 1 part by weight or more and 60 parts by weight or less based on 100 parts by weight of the concrete composition.

In the present invention, the filler may be one or two or more selected from the group consisting of lime powder, Portland cement, slaked lime, fly ash, recovered dust, steelmaking dust, a reinforcing material, and crushed waste aggregate and waste powder.

The crushed waste aggregate and waste powder may refer to waste asphalt concrete (ASCON), waste concrete, waste tires, steelmaking slag, waste plastic, waste glass, waste sand sludge, waste lime powder, waste glass powder, or the like.

According to an embodiment of the present invention, the concrete composition may further include a hardening agent.

According to an embodiment of the present invention, the hardening agent may be a commonly used hardening agent, for example, alkali-activated material, metal oxide, one or a mixture of two or more selected from MgO, cement, and the like, but the present invention is not limited thereto In addition, light MgO and heavy MgO may be used as the hardening agent depending on the area of application. Furthermore, an amount of the hardening agent may be adjusted to adjust a hardening time and an increase and decrease in strength.

In addition, in the present invention, a composition including the modified sulfur and the hardening agent may be provided, and the composition including the modified sulfur and the hardening agent may be used as a fast-setting repairing agent and a fast-setting adhesive and for realizing waterproofness, corrosion resistance, and the like.

According to an embodiment of the present invention, when the hardening agent is cement, the hardening agent is included in an amount of 10 parts by weight or more and 70 parts by weight or less based on 100 parts by weight of the aggregate.

According to an embodiment of the present invention, when the hardening agent is MgO, the hardening agent is included in an amount of 1 part by weight or more and 40 parts by weight or less based on 100 parts by weight of the aggregate.

When the hardening agent is cement, the cement may be used to pave a road in the field at room temperature using a ribbon mixer or a common ready-mixed concrete mixer without the addition of water. Specifically, since the modified sulfur according to an embodiment of the present invention has a honeycomb structure or a network structure, the modified sulfur may contain moisture by itself using a thixotropic phenomenon. Therefore, when the moisture-containing modified sulfur according to an embodiment of the present invention is utilized, a road may be constructed by a common concrete construction method without additional water supply, and the hardening agent may be adjusted to reduce a curing time of the modified sulfur polymer concrete (1 day to 7 days).

The concrete composition according to an embodiment of the present invention may be applied in various civil engineering and construction materials, road pavement, repair and reinforcement, emergency repair, and the like.

According to an embodiment of the present invention, the method of paving a road at room temperature using the concrete composition (asphalt, asphalt concrete) may be applied in the environmentally-friendly road pavement construction performed using only a mixer and a roller without heating equipment regardless of season anywhere, excluding hot ASCON pavement construction and road pavement construction with a heating scheme. In addition, since the concrete composition including the modified sulfur exhibits high adhesion, an initial oil coating operation is unnecessary in asphalt pavement construction, and thus it is possible to omit the prime coating (tack coating) operation.

According to an embodiment of the present invention, the instant construction method using the concrete composition in the field at room temperature compensates for disadvantages of the conventional asphalt or concrete such that high adhesion, chemical resistance, waterproofness, corrosion resistance, high elasticity, high abrasion resistance, and the like may be enhanced, and environmentally-friendly and economic effects such as environmental friendliness, low costs, high quality, and a reduction of a construction period which are characteristics of semi-rigid asphalt, may be obtained.

In addition, there are great environmental benefits such as a reduction in air pollution and landfill and great economic benefits such as fast construction and low costs by reprocessing waste through the recycling of industrial and household waste of landfills and incineration plants to produce the modified sulfur, develop road pavement materials and repairing and reinforcing materials, and construct various modified sulfur polymer concrete structures.

The concrete composition including the liquid-phase modified sulfur according to an embodiment of the present invention replaces the conventional hot asphalt so as to allow the room-temperature construction of modified sulfur polymer concrete (semi-rigid asphalt), that is, simple road construction and repair/reinforcement work using only a ready-mixed concrete mixer and a roller without heating equipment by mixing with a modified sulfur binder in the field.

In addition, since the concrete composition according to an embodiment of the present invention exhibits excellent durability due to less deformation even in hot weather and allows concrete construction without water supply, the concrete composition may be suitable for paving a road in desert areas, mountainous areas, Africa, the Middle East, Southeast Asia, and the like.

Additionally, the conventional asphalt construction does not easily proceed in cold winter because the properties of asphalt are highly likely to be changed by a difference in ambient temperature, whereas the modified sulfur according to an embodiment of the present invention may allow the construction and repair/reinforcement of a road even in sub-zero weather (about −5° C.) due to characteristics of sulfur, such as heat generation and strong resistance to low temperature cracking.

In particular, road construction may be made only with common aggregate and the modified sulfur, so it is most suitable for island areas such as the Philippines, Indonesia, Cuba, and the Caribbean, where there are many islands, and there is no need for asphalt batch plants In addition, there are great environmental benefits and economic benefits by reprocessing waste through the recycling of industrial and household waste in island areas.

Furthermore, in the case of tunnel construction, when construction is made while applying heat, there are economic benefits such as a low dropout rate (rebound rate) caused by strong adhesive strength and waterproofness and a reduction of the construction period caused by omitting tarpaulin work.

In addition, since the modified sulfur according to an embodiment of the present invention continues to be hardened in water, the modified sulfur is very effective for sinkhole repair work, facilitates emergency repair and emergency road establishment by adjusting a hardening time during construction, and allows a road to be opened in a short time, so there is a wide range of economic effects.

Additionally, it is possible to use sand or aggregate containing salinity (including marine waste) due to strong salt resistance and to make the construction of a temporary road only with common soil or sand for paving a temporary road due to strong adhesive strength and high strength.

The modified sulfur according to an embodiment of the present specification may be applied in emergency road repair by adjusting a hardening time and may be applied in the repair and reinforcement of an old asphalt road, wherein the existing old asphalt may be recycled by scrapping only the upper portion thereof (5 cm) using a road crusher, crushing the scrapped waste ASCON or waste aggregate in the field (to 13 mm aggregate level), mixing the crushed waste ASCON or waste aggregate with the modified sulfur of the present invention at room temperature, depositing the resulting mixture on the road whose upper portion has been scrapped with a thickness of 5 cm, and compacting the same.

The edge joint (usually 30 cm to 1 m width) of the conventional asphalt road is commonly constructed with cement or concrete, which is cracked over time due to fatigue resistance and moisture sensitivity of the road and adhesion between heterogeneous materials. On the other hand, in the case of using the modified sulfur of the present invention, the construction may be made regardless of a joint portion, and even if the joint portion is independently constructed with common aggregate or waste aggregate, the above-described problem may be solved due to cohesion between homogeneous materials.

In addition, according to an embodiment of the present invention, the concrete composition may be used as materials of a waterproofing agent, an anti corrosion agent, and the like. The modified sulfur according to an embodiment of the present invention exhibits high functionality, that is, high chemical resistance, corrosion resistance, waterproofness, high strength, high adhesive strength, a quick setting property, and the like. Therefore, the concrete composition may be used as materials of a waterproofing agent, an anti-corrosion agent, a water-stopping agent, various types of adhesives, paint, and the like by enhancing a specific function depending on the area of application.

According to an embodiment of the present invention, when the concrete composition is used as materials of a waterproofing agent and an anti-corrosion agent, a diluent may be further included According to one embodiment, the diluent may include any one selected from the group consisting of ethanol, methanol, methyl ethyl ketone (MEK), toluene, m-xylene, p-xylene, and the like.

In addition, in the case of use of the concrete composition for corrosion prevention and waterproofing, when an anti-corrosion coating is formed, an additive that may enhance the strength of the anti-corrosion coating may be further included.

The concrete composition according to an embodiment of the present invention may be used in place of epoxy or urethane and is environmentally friendly and economical in terms of time and cost because there is no need to apply a plurality of coats such as a top coat, a middle coat, and a bottom coat like in the case of conventional epoxy or urethane. [0165] Hereinafter, the present invention will be described in detail with reference to embodiments. However, embodiments of the present invention may be modified in several different forms, and the scope of the present invention is not limited to the embodiments to be described below. The embodiments of the present invention are provided so that this disclosure will be thorough and complete, and will fully convey the concept of embodiments to those skilled in the art.

### Example 1

### Production of Modified Sulfur

100 g of sulfur and 150 g of oleic acid were introduced into a polymerization reactor at room temperature. The temperature of the polymerization reactor was set to about 120° C. using a temperature controller, and melt polymerization was performed while the blade of the reactor was stopped until the sulfur and other mixing materials completely became a liquid and then rotated when the mixture was converted into a liquid. After the melted mixture was converted into a liquid, temperature of the polymerization reactor was gradually raised by about 20° per hour so that temperature variance inside and outside the synthetic product was as small as possible (about 5° C. or less), but a double-jacketed oil-heated reactor can be used to closely control temperature in the reaction. When the temperature of the melted mixture was 160° C. or more, the state and viscosity of the melted mixture were measured three times or more per hour (after cooling a sample), and the reaction was terminated when the viscosity thereof reached 10,000 cP at room temperature, thereby obtaining modified sulfur.

### Comparative Example 1-1: DCPD

150 g of sulfur and 150 g of dicyclopentadiene (DCPD) were introduced into a polymerization reactor at room temperature. The temperature of the polymerization reactor was set to about 120° C. using a temperature controller, and melt polymerization proceeded until the sulfur and other mixing materials completely became a liquid. After the melted mixture was converted into a liquid that was sufficiently mixed, the temperature of the polymerization reactor was set to about 160° C. and gradually raised to 200° C., and then a reaction was performed. The reaction was terminated when the melted mixture became a dark-brown liquid-phase synthetic product and the viscosity thereof reached 10,000 cP, and the synthetic product was cooled, thereby obtaining solid-phase modified sulfur.

In the case of the modified sulfur produced in Comparative Example 1-1, waterproofness and corrosion resistance can be confirmed. But, when sulfur and DCPD were mixed (in early stage), the sulfur and DCPD had to be mixed while a gas mask was worn due to its disgusting odor, and even after the reaction was terminated, the gas mask had to be worn. Therefore, it is difficult to practically apply this modified sulfur in the industrial field.

### Wheel Tracking Test

In order to confirm dynamic stability of the modified sulfur produced in Example 1, 210 g of the modified sulfur produced in Example 1, 2 kg of sand, 1,000 g of aggregate (13 mm), and 210 g of MgO were mixed at room temperature for 7 minutes, and then the mixture was compacted 65 times using a compactor for an asphalt specimen. At 10 minutes after the compaction, a mold was removed, and the compacted mixture was allowed to stand for 12 hours, thereby manufacturing a specimen.

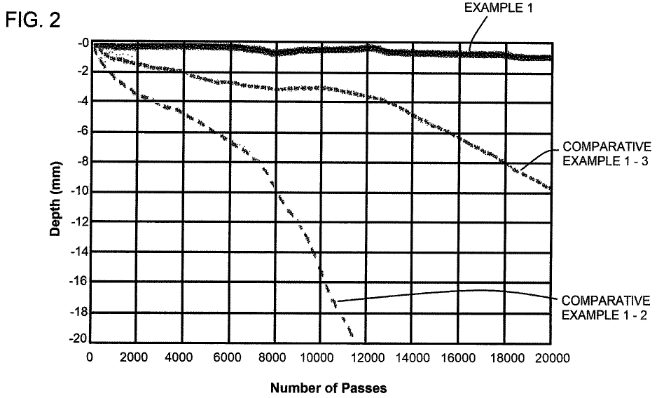

The manufactured specimen, standard straight asphalt manufactured by Twining, Inc (Comparative Example 1-2), and styrene-butadiene-styrene (SBS) asphalt (Comparative Example 1-3) were subjected to a wheel tracking test at an inspection agency (Twining, Inc., California, USA), and results thereof are shown in FIG. 2.

Looking at the results of FIG. 2, it can be seen that the modified sulfur according to an embodiment of the present invention exhibited excellent dynamic stability compared to straight asphalt and SBS-modified asphalt.

### Example 2

In order to confirm that the concrete composition including the modified sulfur according to an embodiment of the present invention can be applied to construct an asphalt-like, flexible pavement road at room-temperature, an experiment was performed as follows.

### Example 2-1

150 g of sulfur, 150 g of oleic acid, 2 g of pine oil (phytoncide), 2 g of dicyclopentadiene (DCPD) as a second modifier, and 2 g of carbon black were introduced into a reactor at room temperature, and melt polymerization was performed while raising temperature to 160° C. thereby producing liquid-phase modified sulfur having a viscosity of 6,000 cP or more. 1,000 g of aggregate (13 mm), 2 kg of sand, and 150 g of MgO as a hardening agent were mixed at room temperature, and then the mixture was introduced into a fine aggregate mixer. Afterward, 180 g of the produced modified sulfur was introduced into the mixer and mixed for 7 minutes, and then the resulting mixture was compacted 65 times using a compactor for an asphalt specimen. At 10 minutes after the compaction, a mold was removed. One day later, the resulting specimen was put into a hot water tank and immersed in 60° C. water for 1 hour. Afterward, the stability and flow value of the specimen were measured. As measured at a weight ratio of 1 kg per specimen, the stability and flow value of the specimen were 12,353 and 23, respectively. During the manufacture of the specimen, the odor of sulfur or other additives was hardly sensed

### Example 2-2

150 g of sulfur, 187.5 g of oleic acid, 2 g of pine oil (phytoncide), and 2 g of carbon black were introduced into a reactor at room temperature, and polymerization was performed for 4 hours while raising temperature gradually to 160° C., gradually, at 20° C. to 30° C. per hour. Afterward, 2 g of phytoncide was added thereto, and one hour later, the polymerization was terminated when viscosity reached 15,000 cP or more at room temperature, thereby producing dark-brown liquid phase modified sulfur.

1,000 g of aggregate (13 mm), 2 kg of sand, and 270 g of MgO as a hardening agent were mixed at room temperature, and then the mixture was introduced into a fine aggregate mixer. Afterward, 210 g of the produced modified sulfur was introduced into the mixer and mixed for 5 minutes, and then the resulting mixture was compacted 65 times using a compactor for an asphalt specimen. Then, a mold was removed, and at 12 hours after the mold removal, the resulting specimen was put into a hot water tank and immersed in 60° C. water for 1 hour. Afterward, the stability and flow value of the specimen were measured, and results thereof were 15,652 and 18, respectively.

It can be seen that, although the mixing time of 5 minutes was reduced in the manufacture of the specimen as compared to Example 2-1, the mixing was performed well. This is because the mixing is performed using a larger amount of the modified sulfur.

### Example 2-3

150 g of sulfur, 150 g of oleic acid, 2 g of dicyclopentadiene (DCPD), and 2 g of carbon black were introduced into a reactor, and polymerization was performed while raising temperature to about 160° C. to 200° C. Afterward, 2 g of phytoncide was added thereto, and the polymerization was terminated when viscosity reached 10,000 cP or more, thereby producing almost black liquid-phase modified sulfur.

The modified sulfur was cooled to obtain rubberized solid-phase modified sulfur, and 200 g of the rubberized solid-phase modified sulfur was crushed into small pieces and diluted with 10 g of ethanol as a diluent to impart fluidity. In addition, 1,000 g of aggregate (13 mm), 2 kg of sand, and 150 g of MgO as a hardening agent were mixed at room temperature, and then the mixture was introduced into a fine aggregate mixer. Afterward, the diluted modified sulfur was introduced into the mixer and mixed for 5 minutes, and then the resulting mixture was compacted 65 times using a compactor for an asphalt specimen. Then, a mold was removed, and at 1 day after the mold removal, the resulting specimen was put into a hot water tank and immersed in 60° C. water for 1 hour. Afterward, the stability and flow value of the specimen were measured, and results thereof were 12,286 and 21, respectively.

In the case of Example 2-3, it can be seen that, although the mixing was performed using a smaller amount of the hardening agent in the fabrication of the specimen, satisfactory stability and a satisfactory flow value were obtained.

Examples 2-1 to 2-3 relate to concrete compositions that are used in asphalt construction at room temperature, and it can be seen from the results of Examples 2-1 to 2-3 that not only brittleness which is the intrinsic disadvantage of sulfur was overcome but also odor was removed and that the concrete composition was environmentally-friendly with room temperature construction and exhibited enhanced durability, which is favorable for maintaining and repairing a road.

Especially, in the case of Example 2-2, it can be seen that the concrete composition was also suitable for emergency repair because hardening was completed in 30 minutes, and the produced modified sulfur also had an aromatic smell of phytoncide.

### Example 3

In order to confirm that the concrete composition including the modified sulfur according to an embodiment of the present invention and waste sources can be applied to construct an asphalt road, an experiment was performed as follows.

### Example 3-1

750 g of waste glass and 315 g of the modified sulfur produced in Example 1 were mixed with 2,000 g of sand, 750 g of gravel (13 mm), and 225 g of a hardening agent (MgO), and the mixture was compacted 65 times using a compactor for an asphalt specimen. At 24 hours after the compaction, the stability and flow value of the resulting specimen were measured, and results thereof were 39,496 and 26, respectively. The stability value is considerably higher than 2,500 which is a standard stability value of conventional room-temperature asphalt, and this concrete composition can be used in a lower layer part of the road

### Example 3-2

240 g of waste vinyl and 315 g of the modified sulfur produced in Example 1 were mixed with 3,000 g of sand, 1,260 g of gravel (13 mm), and 315 g of a hardening agent (MgO) to manufacture two specimens (A and B), and the specimens were compacted 65 times using a compactor for a synthetic asphalt specimen. At 24 hours after the compaction, the stability and flow value of the resulting specimens were measured, and, as a result, the stability values of A and B were 14,641 and 16,515, respectively, and the flow values thereof were 31 and 34, respectively. Since the final compositions of crushed waste plastic were not the same, test scores were obtained for two types, A and B. The stability values of two specimens are also considerably higher than 2,500 which is a standard stability value of conventional room-temperature asphalt, and these concrete compositions can be used in the lower layer part of the road.

### Example 3-3

900 g of steelmaking slag and 315 g of the modified sulfur produced in Example 1 were mixed with 3,000 g of sand, 600 g of gravel (13 mm), and 225 g of a hardening agent (MgO), and the mixture was compacted 65 times using a compactor for an asphalt specimen At 24 hours after the compaction, the stability and flow value of the resulting specimen were measured, and results thereof were 13,292 and 16, respectively. The stability value is considerably higher than 2,500 which is a standard stability value of conventional room-temperature asphalt, and this concrete composition can be used in the lower layer part of the road.

The stability and flow values of the specimens of Examples 3-1 to 3-3 are results measured in accordance with the KS F 2337:2017 test method at Korea Conformity Laboratories.

From the results of Examples 3-1 to 3-3, it can be seen that the modified sulfur according to an embodiment of the present invention was excellent in cohesion, crosslinkability, fluidity, compactability, and storage stability, and thus crushed waste sources can be reused in place of aggregate.

### Example 4

The moisture absorption rate of a hydraulic concrete specimen including the modified sulfur produced in Example 1 and a common concrete specimen were compared. The composition of the concrete specimen was designed using a blending ratio in such a way that the concrete had a compressive strength of 25 MPa and a slump of 20 cm, and the blending was carried out based on the blending ratio in accordance with the road pavement repair, bridge pavement and resurfacing guidelines of the Korea Expressway Corporation.

### Example 4-1

660 g of Portland cement (Ssangyong cement), 345 g of water, 55 g of the modified sulfur produced in Example 1, and 75 g of a water-reducing agent were mixed, and the mixture, 1,000 g of aggregate (13 mm), and 2 kg of crushed stone sand were introduced into an aggregate mixer and mixed for 10 minutes. Then, the resulting mixture was introduced into a specimen mold. Three days later, the mold was removed, and the resulting specimen was cured for the total of 28 days.

### Comparative Example 4-1

A concrete specimen was manufactured in the same manner as in Example 4-1 except that the modified sulfur produced in Example 1 and a water-reducing agent were not included.

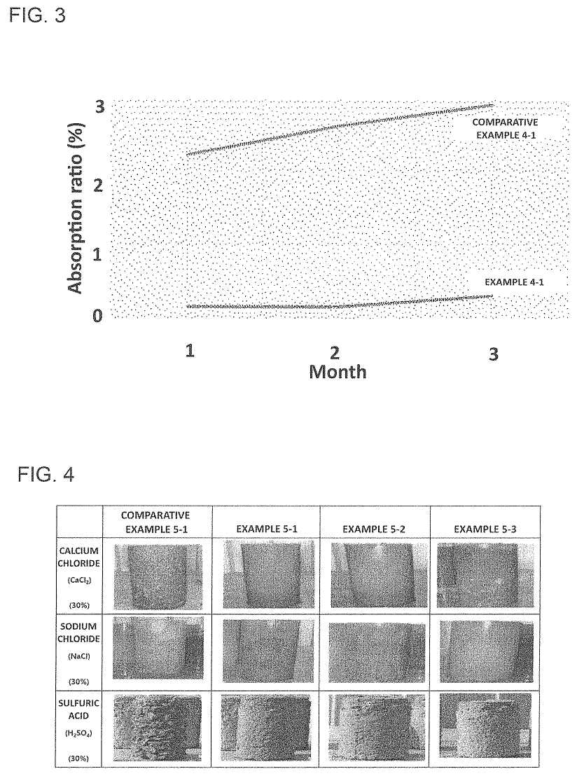

15 L of water was introduced into a 20 L plastic barrel, and then each of the concrete specimens manufactured in Example 4-1 and Comparative Example 4-1 was immersed in the barrel. After 1 month of the immersion, a moisture absorption rate was measured, and results thereof are shown in FIG. 3. In addition, the moisture absorption rate measured after 3 months of the immersion is shown in the following Table 1.

TABLE 1

| | | Comparative |
|---|---|---|
| | Example 4-1 | Example 4-1 |
| Absorption rate (°0) | 0.3 | 2.6 |
| Chemical resistance | O | X |
| Bonding strength (N/cm²) | <200 | |

From the results shown in Table 1 and FIG. 3, it can be seen that the hydraulic polymer concrete composition including the modified sulfur according to an embodiment of the present invention exhibited a low moisture absorption rate, excellent chemical resistance, and high bonding strength.

### Example 5

The chemical resistance of concrete compositions including the modified sulfur according to an embodiment of the present invention were compared.

### Examples 5-1 to 5-3

Concrete specimens were manufactured in the same manner as in Example 4-1 except that the weight of the added modified sulfur was 2%, 5% and 7.5% as compared to the weight of Portland cement, respectively.

### Comparative Example 5-1

A conventional concrete specimen was manufactured in the same manner as in Example 5-1 except that the modified sulfur was not included.

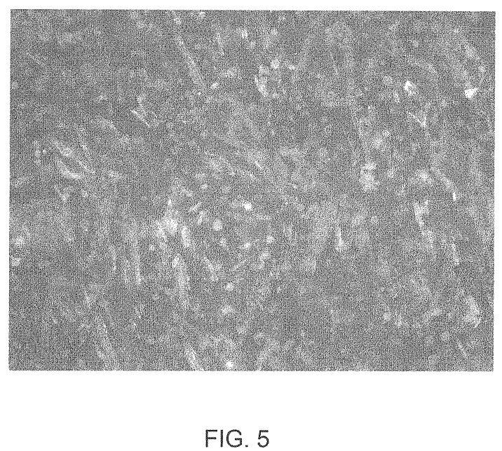

Each of the concrete specimens manufactured in Examples 5-1 to 5-3 and Comparative Example 5-1 was immersed in each of 30% calcium chloride, 30% sodium chloride, and 30% sulfuric acid, which had been diluted with water, for 9 months. Then, the resulting concrete specimens were compared, and results thereof are shown in FIG. 4.

From the results shown in FIG. 4, it can be seen that the concrete composition including the modified sulfur according to an embodiment of the present invention exhibited superior chemical resistance to that of the concrete composition not including the modified sulfur. Specifically, it can be seen that, even though a relatively small amount of the modified sulfur was included compared to Examples 5-2 and 5-3, Example 5-1 also exhibited superior chemical resistance to that of Comparative Example 5-1 in which the modified sulfur was not included.

The term “about” when used herein should be taken to include plus or minus 10% of the stated number, whether a quantity or a temperature in degrees.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

We claim:

1. A method of providing a modified sulfur useful in concrete, asphalt concrete, coatings, sealants, waterproofing and roofing, in a continuous flow reaction, comprising:
continuously feeding molten sulfur and an unsaturated fatty acid modifier into a multi-cell continuous flow reactor,
heating the resulting mixture in the reactor to about 160° C. to 180° C. to polymerize the mixture, while controlling temperature in the cells of the multi-cell flow reactor to avoid runaway exothermic reaction with rapidly rising temperature and carbonization, and while causing thorough mixing of the mixture as it progresses through channels and cells of the multi-cell flow reactor, and
terminating the reaction at a time when the resulting modified sulfur at room temperature exhibits spinnability or has a network or honeycomb structure, including cooling the resulting modified sulfur at termination of the reaction.

2. The method of claim 1, wherein the duration of the method is less than two hours.

3. The method of claim 1, wherein the duration of the method is less than one hour.

4. The method of claim 1, wherein the duration of the method is less than 30 minutes.

5. A concrete composition comprising a modified sulfur produced according to the method of claim 1, a hardening agent and an aggregate.

6. An asphalt concrete composition including a modified sulfur product according to the method of claim 1, a hardening agent and an aggregate.

7. A concrete composition comprising a modified sulfur produced according to the method of claim 1, an aggregate, sand, and a hardening agent.

8. A concrete composition according to claim 7, wherein the hardening agent is magnesium oxide or cement.

9. A method for producing a concrete composition, comprising producing a modified sulfur by the method of claim 1, and combining the modified sulfur with an aggregate and a hardening agent.

10. The method of claim 9, wherein the hardening agent is magnesium oxide or cement.

11. The method of claim 1, wherein the unsaturated fatty acid-based modifier comprises oleic acid.

12. The method of claim 1, wherein the fatty acid-based modifier is a monounsaturated fatty acid-based modifier.

13. The method of claim 1, wherein the modified sulfur produced by the method has a viscosity of 4000 cP to 25,000 cP at room temperature.

14. The method of claim 1, wherein the temperature is raised prior to terminating the reaction, to about 180° C. to 195° C.

15. A method of providing a modified sulfur useful in concrete, asphalt concrete, coatings, sealants, waterproofing and roofing, comprising:
mixing sulfur and an unsaturated fatty acid modifier,
introducing the resulting mixture into a reactor and melting the mixture by heating to at least about 120° C. so that the sulfur of the mixture melts to a liquid state,
polymerizing the resulting liquid sulfur/modifier mixture by raising temperature of the mixture over a period of time, gradually such that exothermic reaction with rapidly rising temperature and carbonization does not occur, to a temperature of about 160° C. to 180° C. causing which ring opening polymerization to occur, while stirring the mixture, and
terminating the reaction by quenching at a time when the resulting modified sulfur at room temperature exhibits spinnability or has a network or honeycomb structure,
the method being completed in two hours or less.
